(19) United States
(12) Patent Application Publication
(10) Pub. No.: US 2009/0304930 A1
(43) Pub. Date: Dec. 10, 2009

(54) SYSTEM AND METHOD OF APPLYING A GEL COAT BRUSH STROKE PATTERN OVER AN IMAGE SURFACE

(76) Inventor: Michael Chaimberg, Montreal (CA)

Correspondence Address: OGILVY RENAULT LLP, 1, Place Ville Marie, SUITE 2500, MONTREAL, QC, H3B 1R1, CA

(21) Appl. No.: 12/133,594

(22) Filed: Jun. 5, 2008

(51) Int. Cl. B05D 3/12; B05C 11/02

(52) U.S. Cl. 427/277; 118/56; 118/696

(57) ABSTRACT

A system and method for automatically applying a gel coat brush stroke pattern over an image surface secured to a support is described. A liquid gel applicator dispenses a predetermined quantity of transparent liquid gel on the image surface. A brush stroking machine is provided with a plurality of brush head modules which are connected to a reciprocating linkage. The linkage causes reciprocal arcuate displacement of bristles secured to the brush head modules. An adjustable support positions the bristles over the image surface for contact with the liquid gel dispensed thereon by the liquid gel applicator. A conveyor displaces the support with the image surface facing up under the liquid gel applicator and the bristles of the brush head modules along a straight axis whereby reciprocating displacement of the bristles imparts brush stroke patterns in the liquid gel over the image surface.

### TECHNICAL FIELD

A system and method for automatically applying a gel coat brush stroke pattern over an image surface secured to a support is described.

### BACKGROUND ART

Various techniques are known whereby to simulate an oil painting by using paper prints of the painting which are usually affixed to a support surface by gluing or lamination and treated to give the resemblance of a real painting. For example in one of my earlier patents I describe a process wherein a print is laminated on a film and then secured to canvass such as by gluing. The canvass is then mounted about a peripheral frame and held taut thereabout. From the rear of the frame a person can observe the canvass giving the impression that the print is either laminated directly on the canvass or is an authentic painting on canvass. To further simulate a real oil painting a gel coat can then be brush stroked on parts of the image surface or on all of the image surface. This technique of brush stroking with a clear varnish or gel coat is expensive if one attempts to simulate the brush strokes which are apparent in the authentic oil painting. However to reduce this labor cost, the technique now used is to apply sporadic varnish brush strokes on the printed image surface. This technique enhances the surface of the print by giving it texture such that a casual observer may see it as a natural oil painting.

Another known technique of simulating an oil painting is described in U.S. Pat. No. 3,964,946, for example, wherein a photograph is glued onto a textured surface. The photograph is then roiled with a nubby roller to force portions of the photograph into the voids of the textured surface of the roller. After the rolling process is completed, a clear sealing lacquer is applied to the photograph surface and which, after drying, seals the surface for excluding moisture and dirt from the photograph. The clear lacquer liquid can be applied to the surface by a brush to simulate brush strokes or may be sprayed over the surface to provide a seal of the entire surface. The gel medium may also have an antique coloring whereby to simulate aging of the image. The gel medium or lacquer may also be applied over the entire surface and then, by the use of a brush or a cheese cloth or a paper towel, light circular motions are applied onto the gel to create a desired swirl effect to give it more texture.

These examples of known techniques are all labour intensive and require special drying racks for the lacquer or gel material to set or cure on the image surface of the frame. Because these processes are labour extensive, most of these reproductions are now fabricated in China where labour costs and some material costs are relatively inexpensive.

### SUMMARY OF INVENTION

It is a feature of the present invention to provide a system and a method for automatically applying a gel coat brush stroke pattern over an image surface secured to a support and which substantially overcome the above mentioned disadvantage of the prior art.

Another feature of the present invention is to provide a system and method for automatically applying a liquid gel over a surface of an image surface and to automatically apply brush stroke patterns into the gel coat over the entire surface and further wherein the gel coat is cured quickly in a drying machine in a successive step of the process.

Another feature of the present invention is to provide a system for automatically applying a gel coat brush stroke pattern over an entire image surface secured to a support and wherein the brush stroke patterns contain different size brush strokes and wherein the texture of the brush strokes within the gel can be controlled to simulate oil paint reliefs over the image surface.

According to the above features, from a broad aspect, the present: invention provides a system for automatically applying a gel coat brush stroke pattern over an image surface secured to a support. The system comprises a liquid gel applicator having control means to dispense a predetermined quantity of transparent liquid gel on the image surface. A brush stroking machine is also provided and it has a plurality of brush head modules connected to a reciprocating linkage, said brush head modules having bristles at a lower end thereof. Motion generating means is connected to the brush head modules to cause arcuate displacement of the brush bristles. Adjustable support means positions the bristles of the brush head modules over the image surface for contact with the liquid gel dispensed thereon by the liquid gel applicator. Displacement means is provided to cause relative displacement between the brush head modules and the image surface along a straight axis whereby reciprocating displacement of the brush head modules causes the bristles to impart brush stroke patterns in the liquid gel over the image surface.

According to a further broad aspect of the present invention there is provided a method of automatically applying a gel coat brush stroke pattern on an image surface secured to a support. The method comprises the steps of applying a liquid gel on the image surface in a controlled amount by relative displacement between the image surface and a gel applicator positioned over the image surface and along a straight axis. The method further comprises the steps of providing a brush stroking machine having a first and second series of aligned brush head modules. The brush head modules have bristles at a lower end thereof. The brush head modules are disposed spaced-apart from one another along a first and second straight parallel axis transverse to said straight axis. The brush head modules along the first and second axes are laterally offset from one another in an overlapping relationship aligned with the straight axis. The relative displacement also causes displacement between the image surface with the liquid gel and the brush head modules while causing arcuate reciprocating motion of the bristles to cause the bristles to impart brush stroke patterns in the liquid gel over the entire image surface.

### BRIEF DESCRIPTION OF DRAWINGS

A preferred embodiment of the present invention will now be described with reference to the accompanying drawings in which:

FIG. 1 is a schematic diagram illustrating the system and method of the present invention for automatically applying a gel coat brush stroke pattern over an entire image surface which is secured to a support;

FIG. 2A is a perspective view showing the gel coat applicator mounted on a support beam with a reciprocating connection;

FIG. 2B is a perspective view of a liquid gel dispensing module provided with a spray head or a bead with four bead dispensing nozzles;

FIG. 3A is a perspective view of the brush stroking machine having a plurality of brush head modules supported thereby and secured to a motor driven reciprocating linkage;

FIG. 3B is a side view of the brush stroking machine of FIG. 3A;

FIG. 4 is a fragmented plan view illustrating the disposition of the brush head modules with respect to the image surface on which is deposited swirls of liquid gel and brush stroke patterns imparted by the bristles of the reciprocating axial displacement of the brush head modules;

FIG. 5A is a perspective view of a bristle attachment member provided with groups of bristles;

FIG. 5B is a view similar to FIG. 5A but wherein the bristles extend all along a circumferential axis of the attachment member;

FIG. 6 is a perspective view of a frame having an image surface illustrating the shape of the gel pattern deposited thereon and the brush stroke patterns;

FIG. 7 is a fragmented cross-section view showing a relief pattern formed in the gel by the bristles of the brush stroking heads; and

FIG. 8 is a schematic illustration showing two series of brush head modules aligned in parallel relationship with the modules offset from one another and wherein the bristle heads are of different diameter sizes along one of the series of brush head modules.

### DESCRIPTION OF PREFERRED EMBODIMENTS

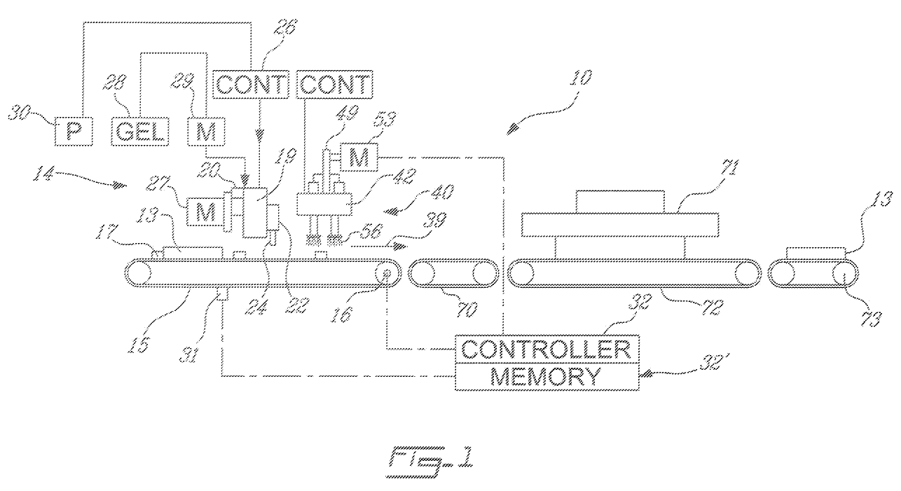

Referring now to the drawings and more particularly to FIG. 1 there is shown generally at 10 the system of the present invention for automatically applying a gel coat brush stroke pattern, as shown at 11 in FIG. 6 over an entire image surface 12′ of a sheet 12 secured to a support 13, as also shown in FIG. 6. The system 10 comprises a liquid gel applicator system 14 which is secured above a conveyor 15 which is driven by a variable drive motor 16. The conveyor 15 is provided with attachment lugs or bars 17 whereby to convey the support frame 13 and its image surface facing up under the liquid gel applicator assembly 34. These attachment bars 17 are displaceably secured to the conveyor belt whereby support frames of different sizes can be adapted to the conveyor. Alternatively, they could be fixed and spaced apart sufficiently to convey frames of different sizes.

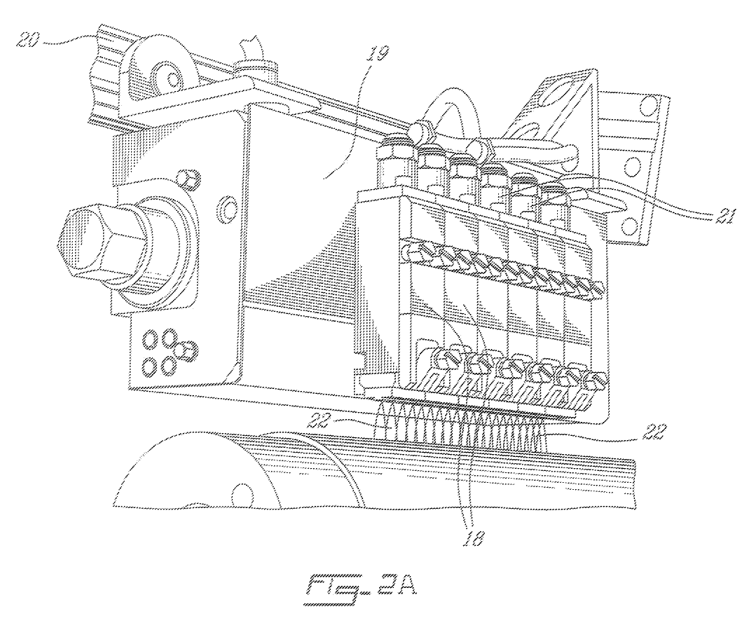

With further reference now to FIGS. 2A and 2B, the liquid gel applicator assembly 14 is comprised of a series of independently controlled liquid gel dispensing modules 18 secured in side-by-side relationship on a support member 19. The support member 19 is displaceably secured to a guide rail 20 whereby the support member 19 and the liquid gel dispensing modules can be axially reciprocated. The liquid gel dispensing modules are secured in side-by-side relationship along the entire width of the conveyor belt 15 and each module is independently detachable for replacement or servicing. The modules are also provided with valves 21 whereby they can be shut-off to dispense liquid gel 22 for only a certain width across the conveyor belt, the width corresponding to the width of the image surface which is to be conveyed thereunder. The valves 21 are pneumatic control valves whereby the liquid gel dispensing modules are precisely actuated and shut-off when a print with an image surface is conveyed thereunder to assure that gel is released only on the image surface.

As shown in FIG. 2B, each of the liquid gel dispensing modules 18 may be provided with a spray nozzle 23 depending on the liquid to be dispensed or with a head 24 having two or more, herein four, gel dispensing nozzles 2S as used with the present invention. The head 24 is one inch long and the nozzles 25 are adapted to dispense gel along a Y, inch wide area. Each nozzle 25 is also independently controlled to be in an “on” or “off” state. Accordingly, the liquid gel released by the dispensing module 18 is adjustable in width within ¼ inch. As also shown in FIG. 1 a reciprocating motor 27 is coupled to the support member 19 attached to the guide rail 20 by a suitable linkage. Liquid gel is contained in a reservoir 28 and supplies a manifold 29 to which the dispensing modules are supplied. A pump 30 maintains the pressure in the gel supply system and manifold. Sensors 31 are also suitably mounted in relation to the conveyor whereby to detect the leading edge and trailing edge of the support frames 13 and feed signals to the main controller 32 which controls the operation of the gel coat applicator modules in relation to the position of the image surface 12′.

As hereinshown the applicator modules are reciprocated transversely of the axial direction of travel 39 of the support frames 13 and as soon as the leading edge 13′ of the frame 13 reaches a precise position under the liquid gel dispensing modules 18 liquid gel 22 is dispensed. Because the print is traveling at a controlled speed and the liquid gel dispensing modules are reciprocated, the gel will be deposited in swirl patterns 33, as shown in FIG. 6, on the image surface and with the pattern of each nozzle 25 being disposed in side-by-side relationship. Accordingly, there are liquid gel beads deposited over the entire width and length of the image surface 12′ but as swirl beads. By controlling the speed of the variable drive motors 16 these patterns will become more compressed or elongated thereby controlling the amount of gel deposited over the entire image surface 12′.

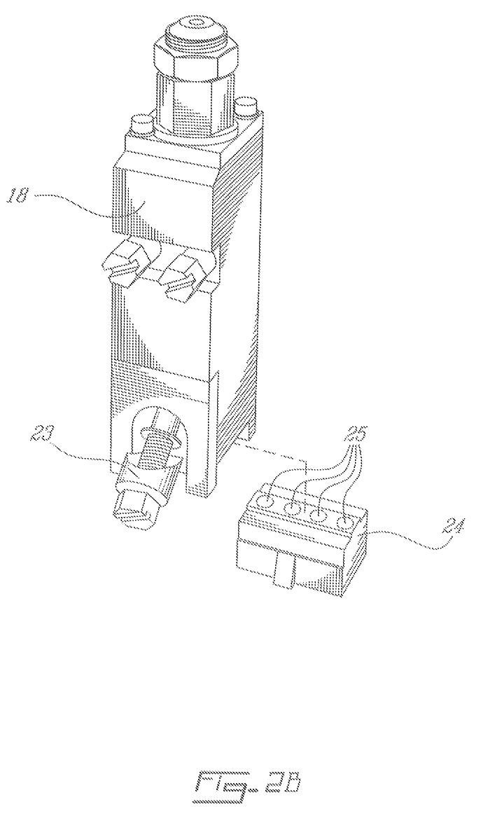

Following the application of the gel onto the image surface 12′, the frame with the image surface is then conveyed under a brush stroking machine 40 which is better illustrated with reference to FIGS. 3A and 3B. The brush stroking machine 40 has a support frame 41 adapted to support an elongated support bar 42 over the conveyor 15. A plurality of brush head modules 43 are secured to the support bar 42. The brush head modules 43 are provided with bristles 44 at a lower end thereof. The brush head modules 43 have a cylindrical support body 45 which is axially rotatably retained in spaced-apart cylindrical bores 46 formed in the support bar 42. As hereinshown, the brush head modules are retained in spaced-apart straight parallel axes 48 and 48′. A reciprocating linkage 47, hereinshown in the form of a T-bar 49, is supported between the two straight parallel axes 48 and 48′. The T-bar has opposed flanges 49′ and 49″ projecting from both sides thereof with the flanges being connected to respective ones of the cylindrical support bodies 45 of the brush modules whereby to axially rotate them in a reciprocating motion, in a clockwise and counter-clockwise direction.

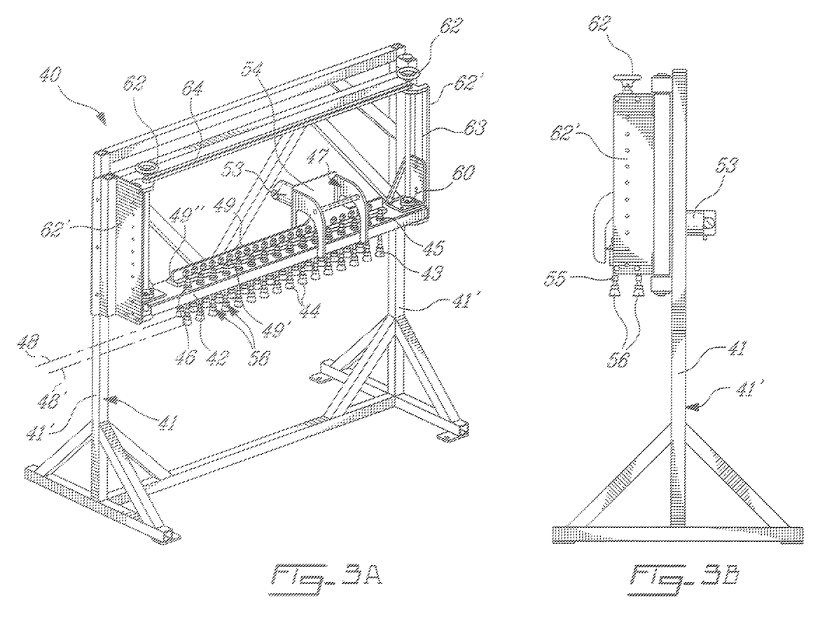

As shown in FIG. 4, the T-bar 49 is herein illustrated in phantom lines and as the T-bar reciprocates in a first direction indicated by arrow 50, the cylindrical bodies along the parallel axis 48′ will be rotated clockwise as indicated by arrows 51 while at the same time the cylindrical bodies 45 along the other parallel axis 48 will be rotated in a counter-clockwise direction as indicated by arrows 52.

As further shown in FIGS. 3A and 3B, the T-bar 49 is connected to a drive, herein an electric motor 53, which is mounted on a support 54 and connected to the T-bar 49 by a suitable linkage, not shown but obvious to a person skilled in the art. Of course, when the T-bar is retracted in a direction opposed to the direction 50 as illustrated in FIG. 4, the heads will reverse their direction and thus the heads along the parallel axis 48′ will now be rotated in a counter-clockwise direction as indicated by arrows 51′ and the heads along the axis 48 will be rotated in a clockwise direction as indicated by arrows 52′.

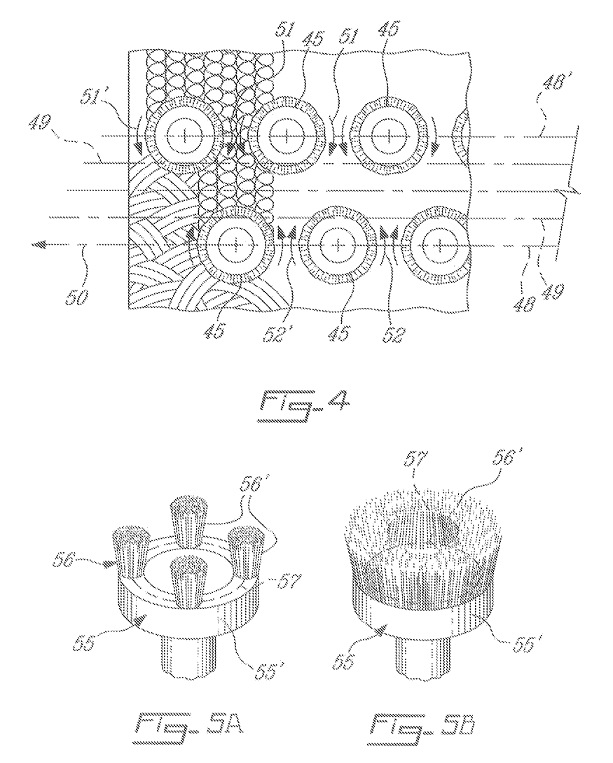

Referring now to FIGS. 5A and 5B, it can be seen that the lower ends of the brush modules 43 have a removable bristle attachment 55. These attachments 55 are equipped with bristles 56. These bristles are secured along a diametrical axis or at least an arcuate portion of the diametrical axis of the bristle attachments 55 which have a circular shape head 55′. The bristles 56 can be provided as four individual bristle groups 56′ disposed transversely to one another along the diametrical axis 57 of the bristle attachment head 55′ or as a continuous bristle of circular shape 56″ as illustrated in FIG. 5B with bristles extending all along the diametrical axis 57. These removable bristle attachments 55 are replaceably connected whereby different shapes or sizes of bristle heads may be provided or replaced as they become worn or removed for servicing or to create a different brush stroke effect.

Referring again to FIGS. 3A and 3B, there is shown a displacement means which causes vertical displacement of the support frame 42 thereby displacing the brush head modules or bristles relative to the image surface 12′ of a frame to be displaced thereunder. This displacement means is constituted by a gear box 60 secured on opposed sides of the support bar 42 and engageable with a toothed rack 61 secured to a respective one of the fixed lateral support walls 62 fixed to the vertical frame posts 41′ on opposed sides of the frame 41. By rotating the handle 62 a connecting rod 63 is axially rotated and the support bar 42 can be vertically positioned. The handles 62 are interconnected together by a link belt 64 whereby the rods 63 can be rotated in unison. Accordingly, there is provided a means for adjusting the horizontal position of the support bar with respect to the conveyor and more importantly to the image surface 12′ of the frame 13. This adjustment means can also be motor driven.

The bristle heads 56 all lie in a substantially common plane, as shown more clearly in FIG. 3B, and the displacement means, herein the handle 62 connected to the gear box 60 permits the adjustment and positioning of the brush heads 56 on the image surface or slightly above the image surface whereby to engage into the liquid gel swirl patterns 33, see FIG. 6, thereby controlling the relief (the thickness of the gel) of the brush stroke patterns made in the liquid gel.

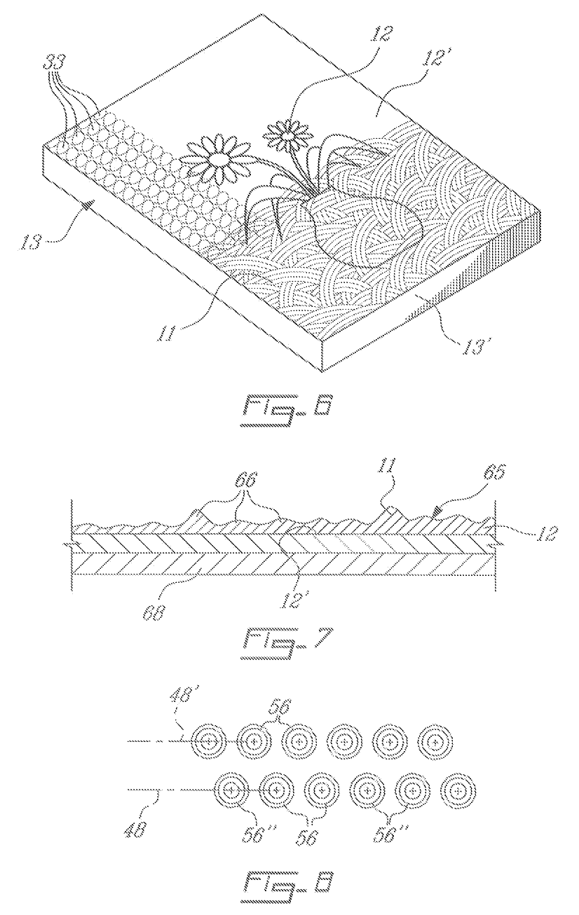

FIG. 7 is an illustration of such relief pattern 65. As hereinshown the relief pattern is comprised of irregular formations 66 formed in the gel brush stroke patterns 11 by the bristles with some of the gel forming peeks and valleys of irregular shape. This is to simulate brush stroke paint relief formed by a real oil painting. Therefore, one can appreciate that depending on the amount of gel deposited on the image surface 12′ and the spacing between the gel and the image surface 12′, this relief pattern can be modified wherein the brush strokes may provide a very thick surface, where the brush strokes are very pronounced and easily visible, or a very thin surface if the brushes are positioned very close to the image surface and less gel is deposited on the image surface. Therefore, a multitude of relief patterns can be created automatically by controlling the speed of the conveyor 15 to vary the amount of gel deposited on the image surface and by controlling the position of the bristle heads with respect to the image surface.

With reference now to FIG. 8, it can be seen that in order to provide still different brush stroke effects over the image surface the bristle heads 56 along one or both of the parallel axes 48 and 48′ can be of different sizes such as bristle heads 56″ along axis 48. The heads 56″ may also be spaced apart along an irregular pattern, that is to say the larger heads 56″ can be positioned after two or three of the regular heads 56 or in an alternating sequence or in any other sequence. This would simulate different brush stroke patterns imitating the use of different size brushes used by an artist having created the artwork represented on the image surface.

It is also pointed of that the conveyor speed can control the shape of the brush stroke patterns whereby a slow speed would make the patterns more compressed and a higher conveyor speed will make the brush stroke patterns 11 more elongated. The speed of the reciprocating motor 53 can also modify the bristle stroke pattern. Also, the speed of the conveyor can be made variable along the length of the image surface whereby to impart into the gel brush stroke patterns of different lengths thereby further enhancing the brush stroke pattern effect to imitate a real painted image surface. Of course this can be programmed in the memory 32′ of the controller 32. With such an arrangement there would need to be a different conveyor positioned under the brush stroking machine 40 and it would have to be synchronized with the conveyor 15.

With further reference now to FIG. 1, it can be seen that after the frame with the image surface has been entirely coated with brush stroke patterns 11, the frame is conveyed by a transfer conveyor 70 or the same conveyor 15 into a UV dryer or curing machine 71 which has its own conveyor 72 operating at a controllable speed. Because the liquid gel has an ultraviolet curable agent therein, the ultraviolet UV curing machine 71 provided with ultraviolet lighting generating UV rays will quickly solidify the liquid gel as the frame 13 is conveyed through the curing machine 71. The frame 13 is then automatically discharged from the curing machine onto a discharge conveyor 73 for packaging at another station.

The system 10 of the present invention therefore provides a method of automatically applying a gel coat brush stroke pattern 11 on an image surface 12′ formed on a sheet 12 and secured to a support, such as the frame 13 shown in FIG. 6. Of course, the frame 13 can be a solid board and the sheet 12 can be laminated on canvass 68, such as shown in FIG. 7, which is held taut over a peripheral frame 13 as is well known in the art. The method can therefore be summarized as comprising the steps of applying a liquid gel on an image surface in a controlled amount by relative displacement between the image surface and the gel applicator machine 20 positioned above the image surface and along the straight axis of conveyance of the frame by the conveyor 15. The frame is then conveyed under a brush stroking machine whereby bristles are reciprocated to form brush stroke patterns into the gel coat entirely over the image surface. By adjusting the spacing between the bristles and the image surface one can create different relief patterns in the gel coat as is desirable and this may depend on the various images imprinted on the sheet 12 secured to the frame 13, or other criteria.

It is within the ambit of the present invention to cover any obvious modifications of the preferred embodiment described herein provided such modifications fall within the scope of the appended claims.

I claim:

1. A system for automatically applying a gel coat brush stroke pattern over an image surface secured to a support, said system comprising a liquid gel applicator having control means to dispense a predetermined quantity of transparent liquid gel on said image surface, a brush stroking machine having a plurality of brush head modules connected to a reciprocating linkage, said brush head modules having bristles at a lower end thereof, motion generating means is connected to said brush head modules to cause arcuate displacement of said bristles, adjustable support means to position said bristles of said brush head modules over the image surface for contact with said liquid gel dispensed thereon by said liquid gel applicator, displacement means to cause relative displacement between said brush head modules and said image surface along a straight axis whereby reciprocating displacement of said brush head modules causes said modules to impart brush stroke patterns in said liquid gel over said image surface.

2. A system as claimed in claim 1 wherein said bristles are secured on an arcuate axis; said brush head modules being secured along at least two straight, spaced-apart, parallel axes in an equidistantly spaced arrangement; said brush head modules along one of said straight parallel axes being offset from said brush head modules on the other of said straight parallel axis.

3. A system as claimed in claim 2 wherein the configuration of said bristles of said brush head modules secured along said at least two straight axes are substantially identical to one another.

4. A system as claimed in claim 2 wherein the configuration of said bristles of said brush heads secured along said one of said straight parallel axes are of different size than the configuration of bristles of said brush heads secured to the other of said straight parallel axes.

5. A system as claimed in claim 2 wherein the configuration of said bristles of said brush head modules secured along at least one of said two parallel axes are of varying sizes.

6. A system as claimed in claim 2 wherein said bristles are formed in circular groups, said groups being secured spaced apart about an arcuate portion of a circumferential axis of a bristle support face of a bristle attachment member of said brush head modules.

7. A system as claimed in claim 2 wherein said bristles are secured along a circumferential axis of a bristle support face of a bristle attachment member of said brush head modules.

8. A system as claimed in claim 7 wherein said bristle attachment members of said brush head modules are axially rotatably retained in spaced-apart cylindrical bores of a support bar along said two straight parallel axes, said reciprocating linkage being an elongated connector plate supported between said two straight parallel axes and connected on opposed sides thereof to respective ones of said attachment members secured along said two straight parallel axes, and motor means to impart a reciprocating longitudinal axial displacement of said elongated connector plate to cause said brush head modules along said one of said two parallel axes to be axially rotated in counter rotation to said brush head modules along the said other of said two parallel, axes.

9. A system as claimed in claim 8 wherein said displacement means is constituted by a vertically displaceable support frame to which said support bar is secured, said displaceable support frame having adjustment means for adjusting the horizontal position of said support bar with respect to said displacement means, said bristles of all said brush head modules lying in a common plane.

10. A system as claimed in claim 9 wherein said adjustment means controls the distance between said bristles of said brush head modules and said image surface thereby controlling the relief of said brush stroke patterns in said liquid gel.

11. A system as claimed in claim 2 wherein said liquid gel applicator is comprised of a series of independently controlled liquid gel dispensing modules secured side-by-side along a straight elongated support member secured to a reciprocating drive, each dispensing module being connected to a gel supply manifold, each module having two or more nozzles, pneumatic control means to control the operation of each of said modules and each of said nozzles whereby to adjust the width of a gel curtain to be dispensed on said image surface.

12. A system as claimed in claim 11 wherein said liquid gel dispensing modules are replaceably secured to said elongated support member, each module having four gel dispensing nozzles which are independently controlled, each nozzle capable of dispensing gel along a ¼ inch portion of said image surface where said displacement means is operative to effect displacement between, said image surface and said liquid gel dispensing modules.

13. A system as claimed in claim 2 wherein said displacement means is a conveyor, said support of said image surface being retained and displaced by said conveyor with said image surface facing up whereby said image surface is conveyed under said liquid gel applicator and said brush head modules.

14. A system as claimed in claim 13 wherein said conveyor has a speed adjustment drive to control the speed of displacement of said image surface, and sensor means to detect the position of said image surface relative to said liquid gel applicator and said brush head modules, said conveyor speed controlling the shape of said brush stroke patterns.

15. A system as claimed in claim 14 wherein said speed adjustment drive is controlled by a programmable controller whereby said speed of said conveyor may be made variable along the axial length of movement of said image surface as it is displaced under said bristles of said brush head modules to vary the shape of said brush stroke patterns.

16. A system as claimed in claim 14 wherein said speed adjustment drive is controlled by a programmable controller whereby to adjust the speed of travel of said image surface as it travels under said liquid gel applicator whereby to control the amount of liquid gel and density thereof dispensed on said image surface.

17. A system as claimed in claim 1 wherein said liquid gel has an ultraviolet curable agent, and a UV (ultraviolet) dryer having conveyor means to convey said image surface with said liquid gel brush stroke patterns through said dryer to solidify said liquid gel.

18. A method of automatically applying a gel coat brush, stroke pattern on an image surface secured to a support, said method comprising the steps of:
i) applying a liquid gel on said image surface in a controlled amount by relative displacement between said image surface and a gel applicator positioned above said image surface and along a straight axis,
ii) providing a brush stroking machine having a first and second series of aligned brush head modules, said brush head modules having bristles at a lower end thereof, said brush head modules being disposed spaced-apart from one another along a first and a second straight parallel axis transverse to said straight axis, said brush head modules along said first and second axes being laterally offset from one another in an overlapping aligned relationship aligned with said straight axis,
iii) effecting relative displacement between said image surface having liquid gel deposited thereon and said brush head modules while causing arcuate reciprocating motion of said brush head modules to cause said bristles to impart brush stroke patterns in said liquid gel over said entire image surface.

19. A method as claimed in claim 18 wherein said step (i) comprises applying a plurality of closely spaced rows of said liquid gel over said image surface by displacing said image surface under said gel applicator at a controlled predetermined speed.

20. A method as claimed in claim 19 wherein each said rows of liquid gel are formed by applying a bead of said liquid gel by reciprocating motion of a plurality of aligned gel dispensing nozzle heads while said image surface is displaced transversely under said aligned gel dispensing nozzle heads whereby to deposit spirals of said beads of liquid gel to provide for a substantially even distribution of said gel over said entire image surface by said bristles.

21. A method as claimed in claim 20 wherein said image surface is displaced by engagement of said support of said image surface on a conveyor.

22. A method as claimed in claim 18 wherein said brush head modules are provided with groups of bristles disposed spaced-apart about a circumferential axis of a bristle attachment member, each said brush head module being secured to a support bar and a reciprocating motor secured to said support bar, said step (iii) of causing said reciprocating motion consists of reciprocating said support bar to cause said brush head modules to be axially rotated to impart reciprocating displacement of said bristles to form brush stroke patterns in said liquid gel.

23. A method as claimed in claim 22 wherein said step (iii) comprises displacing said support on a belt conveyor with said image surface facing up and controlling the speed of said conveyor to obtain desired brush stroke patterns in said liquid gel coat.

24. A method as claimed in claim 18 wherein after step (iii) there is further provided the step of conveying said image surface through a dryer to solidify said gel coat brush stroke patterns.
